(19) United States
(12) Patent Application Publication
(10) Pub. No.: US 2025/0023221 A1
(43) Pub. Date: Jan. 16, 2025

(54) RETRACTABLE ANTENNA FOR UNMANNED UNDERSEA VEHICLE

(71) Applicant: TRITON SYSTEMS, INC., Chelmsford, MA (US)

(72) Inventors: Angelica CARDONA, Dracut, MA (US); Matthew SCHEUER, Methuen, MA (US); Evangelos LIVIERATOS, Medford, MA (US); Rafael MANDUJANO, Arlington, MA (US); Ethan HOEFLER, Stoneham, MA (US); Tyson LAWRENCE, Highland Ranch, CO (US)

(21) Appl. No.: 18/773,518

(22) Filed: Jul. 15, 2024

Related U.S. Application Data
(60) Provisional application No. 63/513,590, filed on Jul. 14, 2023.

(51) Int. Cl. H01Q 1/10; H01Q 1/34; H01Q 21/06

(52) U.S. Cl. CPC H01Q 1/103; H01Q 1/34; H01Q 21/062

(57) ABSTRACT

Disclosed is a retractable antenna system designed for enhancing communication capabilities in sea environments for unmanned undersea vehicles (UUVs). The system includes a housing, a retractable antenna system with a central mast ending in a yoke, and an actuator attached to the housing to enable the rotation of the central mast in and out of the housing. Additionally, attachment means are provided for external fixation of the system to the UUV. This innovative design allows for the selective deployment and retraction of the antenna system, providing improved communication functionality for UUVs operating in challenging underwater conditions.

### CROSS-REFERENCE TO RELATED APPLICATIONS

This application claims benefit of priority to U.S. Provisional Application No. 63/513,590 filed Jul. 14, 2023, the entirety of which is hereby incorporated by reference.

### GOVERNMENT INTERESTS

This invention was made with Government support under Contract No. N68335-21-C-0256 awarded by the Department of the Navy. The United States Government has certain rights in this invention.

### BACKGROUND

Mission performance of unmanned undersea vehicles (UUVs), particularly medium-sized UUVs, is limited by communication and data exfiltration, which in turn is limited by antenna performance. The size and shape of antennas for MUUVs are significantly restricted by overall drag requirements.

Prior approaches to this problem use a stationary antenna, significantly sacrificing frequency performance and negatively impacting drag forces on the vehicle. Some approaches use a telescoping device which could add complexity as the apparatus would require the use of a drive mechanism and gearbox instead of a single servo motor. Approaches that use a telescoping device typically also require space within the vehicle to accommodate the antenna when not in use, further restricting the size and shape of the antennae. Accordingly, there is a need for alternative approaches.

Previous approaches to providing communication capabilities for unmanned undersea vehicles (UUVs) have involved fixed antenna systems that are permanently mounted on the exterior of the vehicle. These fixed antenna systems are limited in their ability to adapt to changing environmental conditions and may be susceptible to damage during deployment and retrieval operations. Additionally, the fixed nature of these antenna systems may restrict the maneuverability and stealth capabilities of the UUV, potentially compromising mission success in sensitive sea environments.

### SUMMARY

Some embodiments provide a retractable antenna system for use with an unmanned undersea vehicle (UUV) for improved communications in sea environments, the retractable antenna system comprising a housing; and a retractable antenna system, capable of selective deployment out of and retraction into the housing, the retractable antenna system comprising: a central mast terminating at one end with a yoke, and an actuator, which is affixed to the housing, such that the central mast may rotate into and out of the housing via activation of the actuator, further comprising at least two antenna elements, at least one of which is adapted to unfold from the mast during deployment such that it extends laterally from the central mast.

Some embodiments provide a retractable antenna system for use with an unmanned undersea vehicle (UUV) for improved communications in sea environments, the retractable antenna system including: a housing, a retractable antenna system, capable of selective deployment out of and retraction into the housing, the retractable antenna system including: a central mast terminating at one end with a yoke, and an actuator, which is affixed to the housing, such that the central mast may rotate into and out of the housing via activation of the actuator; and attachment means for affixing the system externally to the unmanned undersea vehicle (UUV).

Some embodiments provide a retractable antenna system, wherein the housing further includes a hydrodynamically shaped housing to minimize drag, an access panel selectively moveable between open and closed states to facilitate deployment or retraction of the antenna system.

Some embodiments provide a retractable antenna system, wherein the access panel is selected from one or more doors or panels.

Some embodiments provide a retractable antenna system, wherein the retractable antenna system includes: a main mast, which is rotatably affixed at one end to the housing, such that when deployed, the main mast can rotate and maintain a position that is about 0 degrees to about 90 degrees from horizontal, a plurality of antenna elements each of which is rotatably affixed to the main mast, and selectively moveable between a stowed position and a deployed position.

Some embodiments provide a system, wherein the size and placement of the antenna elements is selected based up a number of parameters including UUV size, mission, antenna interference concerns, or combinations thereof.

Some embodiments provide a system, wherein the attachment means for affixing the system externally to the UUV allows for permanent attachment of the system to the UUV.

Some embodiments provide a system, wherein the attachment means for affixing the system externally to the UUV allows for removable attachment of the system to the UUV.

Some embodiments provide a system, wherein the attachment means include a plurality of straps which extend around the UUV body and attach to opposite sides of the housing to secure the housing to the UUV.

Some embodiments provide a system, wherein one or more different type of antennae or other sensory equipment are deployed.

Some embodiments provide a retractable antenna system for use with an unmanned undersea vehicle (UUV) for improved communications in sea environments, the retractable antenna system including: a housing having a hydrodynamic shape to reduce drag, a lower surface which is sized and configured to compliment the size and shape of the UUV to which it is attached, one or more buoyancy fairings, one or more access panel selectively moveable between open and closed states to facilitate deployment or retraction of the antenna system; and an antenna assembly, capable of selective deployment out of and retraction into the housing, the antenna assembly including: a mast having a longitudinal axis, a first antenna, mounted atop the mast, a second antenna including one or more retractable antenna element, wherein the second antenna opens to a position substantially perpendicular to a longitudinal axis of the mast in a deployed status and closes to a position substantially parallel and adjacent to the mast when in an un-deployed status, wherein the mast is rotatably coupled to the housing, and operably coupled to an actuator for movement between deployed status and un-deployed status.

Some embodiments provide a retractable antenna system, wherein the mast includes a third antenna.

Some embodiments provide a retractable antenna system, wherein the third antenna is a high frequency antenna, the second antenna is a very high frequency antenna, and the first antenna is a multi-function ultra-high frequency antenna.

Some embodiments provide a retractable antenna system, wherein the second antenna includes 2 or more dipole antenna elements arranged opposite one another about the mast, and attached to the mast via hinges and wherein each dipole antenna element is connected by a linkage to a runner which is mounted to slide along the length of the mast, such that each dipole antenna element rotates together from retracted to deployed positions.

Some embodiments provide a retractable antenna system, further including attachment means for affixing the housing externally to the unmanned undersea vehicle (UUV).

Some embodiments provide a retractable antenna system for improved communications in sea environments including: a housing, a retractable antenna system, and attachment means for affixing the system to the outer body of an unmanned undersea vehicle (UUV).

Some embodiments provide a retractable antenna system, wherein the housing further includes a hydrodynamically shaped housing to minimize drag, an access panel selectively moveable between open and closed states to facilitate deployment or retraction of the antenna system.

In some embodiments, the access panel can be coupled in motion with the antenna by a kinetic mechanism that does not require external power, such that when the antenna deploys, the mechanism moves the panel to an open state; when the antenna stows, the mechanism moves the panel to a closed state.

In another embodiment, the system housing can contain a separate actuating element for the panel, such that the panel can move independent of the antenna motion.

In another embodiment, there is no separate actuating element for the panel. The antenna motion opens and/or closes the panel.

In another embodiment, the antenna stows itself in such a way that it becomes the enclosure/housing.

Some embodiments provide a retractable antenna system, wherein the access panel is selected from one or more doors or panels.

Some embodiments provide a retractable antenna system, wherein the retractable antenna system includes: a main mast, which is rotatably affixed at one end to an actuating element (linear and/or rotary actuators) such as but not limited to a servo motor, such that when deployed, the main mast can rotate and maintain a position that is about 0 degrees to about 180 degrees from horizontal, a plurality of antenna elements each of which is rotatably affixed to the main mast, and selectively moveable between a stowed position and a deployed position.

Some embodiments provide a system, wherein the size and placement of the antenna elements are selected based up a number of parameters including UUV size, mission, antenna interference concerns, or combinations thereof.

Some embodiments provide a system, wherein the attachment means for affixing the system to the outer body of the UUV allow for permanent attachment of the system to the UUV.

Some embodiments provide a system, wherein the attachment means for affixing the system to the outer body of the UUV allow for removable attachment of the system to the UUV.

Some embodiments provide a system, wherein the attachment means include a plurality of straps which extend around the UUV body and attach to opposite sides of the housing to secure the housing to the UUV.

Some embodiments provide a system, wherein one or more different type of antennae or other sensory equipment are deployed. Such as a camera or other ISR devices and sensors.

The antenna could be used for sending and/or receiving communications, and/or for jamming communication signals. For example, this could be above and/or below surface, and could be any suitable signal, for example RF, acoustic, optical, etc.

The mast could also be used to deploy sensors underwater, e.g. a contact sensor, magnetometer, CTD, turbidity, chemical, etc. Such sensors could be used to trigger a munition or other event.

The mast could be deployed below water for sonar (likely to the side or downward instead of from the top of the UUV). In some instances, dipoles like those deployed from the sides of the antenna are also useful to create sonar vector sensors.

Munitions and weapons such as lasers could be mounted to the deployed structure.

Fault detection sensors on the mast with a reed switch in the housing may be used to determine if the mast has retracted properly.

The system could be deployed without motors all together by employing springs or other elastic structures to deploy the mechanism. The system may also be deployed with hydraulics, pneumatics, nitinol, or other artificial muscles including soft robotic mechanisms.

Relative flow could be used to retract or fold up the system. Combined with use of springs for deployment this could result in an unpowered solution. When the vehicle comes to the surface the system would deploy because it is out of the water flow (air provides much less drag). When the vehicle submerges the drag of the water flow over the system would push the mast down and cause the antenna elements to fold. Baffles may be used to create additional drag where desirable. High damping would likely be desirable in such a system to prevent the system from retracting due to intermittent forces such as wave impact.

The mast could be made to be frangible such that it could break off in the event of impact. This could be of value to avoid entanglement or damage to other parts of the vehicle in the event of an unintended impact with a net or other underwater obstacle or to allow the vehicle to enter a tube or other docking station when the antenna will not retract.

The system may include its own power supply, radio or other onboard components to support the communication or sensor equipment deployed by the system.

Parts of the system could be flooded or dry.

### BRIEF DESCRIPTION OF THE DRAWINGS

Aspects, features, benefits and advantages of the embodiments described herein will be apparent with regard to the following description, appended claims, and accompanying drawings where:

FIG. 1A is a schematic depicting deployed retractable antenna assembly in a retracted position in accordance with some embodiments.

FIG. 1B is a schematic depicting a retractable antenna assembly in a deployed position in accordance with some embodiments.

FIG. 2 is a photograph of a prototype according to some embodiments.

FIG. 3 is a schematic depicting one embodiment of a retractable antenna assembly in accordance with one embodiment, housing and UUV not shown, for clarity.

FIGS. 4A-4D depict the retractable antenna assembly at various stages of the retraction/deployment cycle in accordance with one embodiment.

FIGS. 5A and 5B show an exemplary outrigger system employing four outrigger arms that further comprise two forward facing outrigger arms and two rear facing outrigger arms.

FIG. 6 depicts a perspective view of a fully deployed system with outrigger arms.

FIG. 7 depicts an alternative design, with a single outrigger arm on each side (left and right), rather than a pair of forward outriggers and a pair of rear outriggers.

FIGS. 8A and 8B depict an alternative outrigger arrangement, where the sidewalls of the housing are hinged along the UUV so as to open outwardly to form the outrigger arms.

### DETAILED DESCRIPTION

Communications and data exfiltration are key limiters of mission performance in unmanned systems, with smaller platforms such as small-sized and medium-sized UUVs facing limits on antenna size and construction. MUUV's multi-mission concept is served by a modular antenna approach to deliver the specialized antenna performance required particularly on submarine-launched missions.

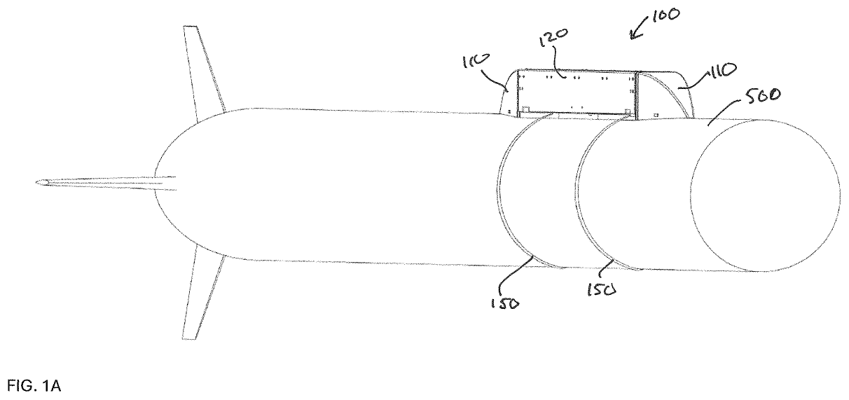

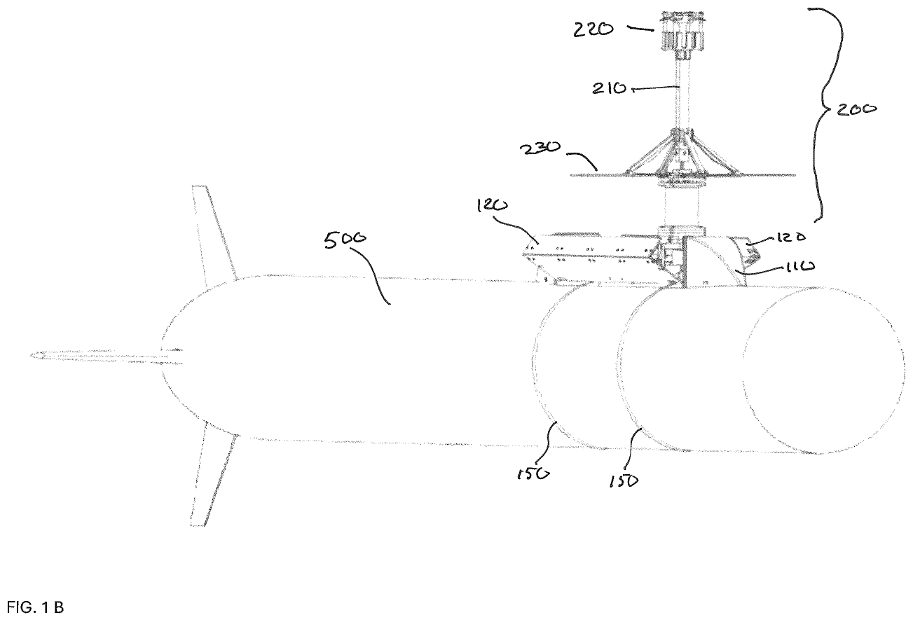

The system disclosed herein is a “backpack” style add-on capability to MUUVs. A vehicle outfitted with an exemplary system, shown in FIGS. 1A and 1B, may surface and rapidly deploy the antenna. The antenna can be directed to a desired angle between zero and 180 degrees to the horizontal. This directionality capability can provide improved performance in cases when the vehicle is operating at higher latitudes. When the mission RF communications are complete, the antenna retracts and stows. The deployment and retraction cycles are each currently 5 seconds long and can be adjusted per mission needs. The system's dry weight of 5.5 lbs is easily accommodated to keep the vehicle well-behaved on the surface in the fully deployed state, as was shown during sea testing. A lightweight antenna structure places low and high-frequency elements at least 0.5 m above a reference ground plane. This enables reliable communication in up to sea state 2 conditions where wave height may be as high as 0.5 m. In such conditions, the antenna structure will have compliant features and back drivable motors to mitigate structural failure. At-sea testing showed the actuators have enough capacity to stow the antenna while the vehicle is underway at the surface, traveling up to a speed of 5 knots. This indicates the system is robust to withstand significant dynamic forces due to wave action at the water surface. The system is designed as a neutrally buoyant wet volume, enclosed to minimize vehicle drag. Additionally, the backpack design provides redundancy against in-mission failures. In the event of an antenna failure, the system will be able to be jettisoned from the MUUV. Further, the system stows completely in an unpowered state.

In some embodiments, the system is designed and configured for an operational environment that is a highly dynamic one, with sea state 2 conditions affording wave heights up to 0.6 m at high frequency. Varying wave action affects the effective ground plane and platform geometry seen by each antenna element on the modular antenna system disclosed herein. The system described herein addresses ground plane, platform, and co-location effects on all antenna elements. The system can be effectively ruggedized and communicate in such a dynamic environment.

The effort to integrate with a vehicle will drive refinement of system interface requirements such as selection of ruggedized RF and electrical connections and structural considerations for a stowage enclosure conformable to vehicle hull. The performance of the antenna structure and actuation elements will be adapted for use at the surface in up to sea state conditions and undersea at UUV operational depths, with minimal effect on drag and/or roll stiffness when retracted and when fully stowed when the vehicle is underway.

In light of the demands and concerns discussed above, described herein is an improved antenna system suitable for attachment to a UUV that has the capability of unfolding from within a compact, minimal-drag housing into a larger, appropriately sized and shaped antenna structure. The retractable antenna for improved communications in sea environments disclosed herein is a modular UUV “backpack” antenna that provides high frequency coverage within constraints for submarine-launched UUVs, defined by the U.S. Navy.

The system disclosed herein has improved multi-band antenna performance due to its larger unpacked form factor when compared to smaller antennae often used with UUVs. Additionally, in its compact state, the system has a negligible impact on drag compared to stationary antennas on MUUVs. Complexity, cost, and space constraints in UUVs typically persuade against retractable antennas, which require housing space for both the antenna and its actuation components within the hull of the vehicle. Therefore, nearly all MUUVs today use small, permanently extended external antennas that are raised above the vehicle, thus negatively impacting drag and resulting in subpar radiofrequency performance due to their reduced size. The result is a failed compromise between drag and radiofrequency performance.

One of the challenges was to provide superior antenna capabilities in a relatively compact unit, which when not deployed would have minimal impact on performance of the UUV. FIGS. 1-4 depict one embodiment of a retractable antenna system in accordance with this disclosure.

FIGS. 1A and 1B depict a UUV 500 with a retractable antenna assembly 200 for improved communications in sea environments. As shown, the retractable antenna system 200 includes a housing 100 having a hydrodynamic shape to reduce drag, a lower surface (not shown) which is sized and configured to complement the size and shape (e.g. curvature) of the UUV 500 to which it is attached, one or more buoyancy fairings 110, one or more access panel 120 selectively moveable between open and closed states to facilitate deployment or retraction of the antenna assembly 200. An antenna assembly 200, capable of selective deployment out of and retraction into the housing 100 includes a mast 210 having a longitudinal axis, a first antenna 220, mounted atop the mast 210, a second antenna 230 comprising one or more retractable antenna elements, wherein the second antenna elements open to a position substantially perpendicular to a longitudinal axis of the mast 210 in a deployed status and closes to a position substantially parallel and adjacent to the mast 210 when in an un-deployed status. The mast 210 is rotatably coupled to the housing 100, for example by a yoke 112 such that the mast can be moved and held at any angle from about 0 degrees to about 180 degrees. The mast 210 is operably coupled to an actuator 114, such as a motor, for example a brushless servo motor, for movement between deployed status (at any angle from about 0 to about 180 degrees) and un-deployed status enclosed within the housing. The various antenna, actuator and other components may be connected to on-board systems via wires. The above-described features may be used in any combination with each other, and some embodiment will employ each of the described features, while other applications will require embodiment with a selection of such features. The antenna system may be adapted according to mission needs. In some instances, the mast, itself, comprises a third antenna.

Although any combination of antenna systems can be used, in one embodiment, the third antenna is a high frequency antenna, the second antenna is a very high frequency antenna, the first antenna is a multi-function ultra-high frequency antenna (e.g. GPS, iridium). The system contains multiple antenna elements that work independently of each other to provide the user with multi-band RF capability. Compared to an ultra-wide frequency capable antenna with a single radiative element, this system, comprised of multiple radiative elements, does not require compromise in RF performance—each element can be optimized for radiation in a desired part of the frequency range of interest. The system is additionally modular; any element can be removed and/or simply not used to reduce size, weight, and power (SWaP) if capability in that frequency range is not needed. The retractable design maximizes capability, in a compact space when not in use.

A retractable antenna for improved communication as disclosed herein includes a hydrodynamically efficient housing, adapted for removeable or permanent attachment to the outer surface of a UUV. Within the housing is an antenna array which can be substantially completely stowed within the housing, and may be selectively deployed, typically by rotation and/or unfolding. Any suitable antenna or combination of antennae may be used. Antennae may work independently of each other or in coordination. This description will focus on certain antennae and deployment mechanisms, but any suitable antenna and deployment mechanism may be used.

When the UUV is surfaced, antenna deployment may be selectively engaged. This may be automated when sensing the surface, controlled by a remote operator, or other functionality. The antenna array actuates out of its stowed position within the housing and unfolds. The housing may be provided with a hinged door or doors, a sliding panel or panels, or other feature which allows the selective stowing and deployment of the antenna apparatus within. The antenna system is driven by a rotary actuator, such as but not limited to a servo motor, in some instances two servo motors.

The main mast is attached to a primary servo motor that can raise the mast from the stowed position to any specific angle between 0 and 180 degrees to the horizontal.

When the mast is raised above 0 degrees to the horizontal, the antenna elements may hinge from a vertical position to a horizontal position by the force of gravity alone.

Alternatively, a second servo may act as a winch, winding a cable that is fed through a hollow center mast and is attached to a runner component that slides up and down the exterior of the center mast freely. The runner component is elastically attached to the top of the center mast and rests in this position in its natural state. When the winch is wound, the cable pulls the runner component down towards the base, and consequently causes the four (4) antenna elements to hinge from their vertical position down until they reach horizontal. The shape and construction of the antenna elements can be any suitable design including but not limited to square, hollow arms. This is the final deployed position of the antenna. When the MUUV has completed communications, the action is reversed, and the antenna retracts back into it stowed position, first by unwinding the winch, and secondly by driving the primary servo to collapse the assembly back into the stowed container. Communications includes but is not limited to transmitting, receiving, broadcasting, etc. The antenna can be designed to do all or any of those things while in use.

A retractable antenna system for improved communications in sea environments as disclosed herein comprises a “backpack” style, modular antenna system for attaching to the external surface of a UUV.

The retractable antenna system comprises a housing 100, an attachment mechanism 150 for affixing the housing 100 to a UUV 500, and a retractable antenna assembly.

The system is non-invasively attached to a UUV via clamps, straps or other means that strap the system onto the hull of the UUV. There may also be electrical connectors that permit signal, power and data transfer between the antenna and the UUV electrical systems.

The housing is sized and configured into a minimal form factor to reduce drag, weight, and other factors that could negatively impact performance of the UUV. The housing is configured to selectively allow for storing and deploying a retractable antenna assembly contained within the housing. Upon selective deployment of the retractable antenna assembly, the housing allows for the antenna to deploy from within the housing. This may be achieved in any suitable manner. The housing itself, for example, could be hinged to open for such deployment, or may contain, doors or panels which open to allow such deployment. The housing is shaped and configured to minimize drag while maximizing storage capacity, so that the retractable antenna assembly need not sacrifice size and therefore radio performance.

The attachment mechanism used to affix the housing to the UUV may be any suitable mechanism. It may be permanent or removable. In some embodiments, the attachment mechanism will include straps, bands, belts, industrial hook and loop fasteners, cleats, bolts, rivets, screws, or any other suitable means for attaching the housing 100 to the UUV, while minimizing drag. Additional components may be employed for drag-reducing effects, such as rubber gaskets, or similar components to seal any gap between the housing 100 and the UUV.

The retractable antenna assembly will generally include a main mast, a plurality of antenna elements affixed to the main mast, and an actuator (e.g. linear or rotary) to drive the main mast and/or plurality of antenna elements.

The main mast is rotatably affixed to an actuator, such as but not limited to a rotary actuator (e.g. servo motor), typically at a pivot point as close as possible to the crown of the UUV hull. In a stowed position, the main mast is approximately parallel to the surface of the UUV. It will be understood that there may be a slight angle in the stowed position, but the entire antenna assembly will be stowed and completely contained within the housing. The main mast is rotatably coupled to the housing via a joint, such as, but not limited to a hinge. Any appropriate joint may be used depending on the needs of the system and UUV combination. Examples include but are not limited to hinges, ball and socket joints, rotary unions, swivel joints, etc. These may be spring-loaded to aid deployment or retraction. Deployed rotation may be anywhere from about 0° to about 180 from the surface of the UUV (which when surfaced approximates horizontal). The amount of rotation can be fixed or dynamically controlled by a user or on-board sensors depending on mission needs, current conditions, the size of the antenna assembly when deployed, and other factors. Rotation is typically facilitated via an actuator, such as but not limited to a servo motor which is a rotary actuator. The servo motor is appropriately sized keeping in mind size and weight constraints of the UUV, as well as weight and size of the antenna assembly 200 to be deployed and desired deployment/stowage time. Deployment/stowage time is typically around 3 seconds to 20 seconds. Five second deployment/stowage times are sufficient for most applications.

To the main mast a plurality of antenna elements are attached. Each of the plurality of antenna elements is rotatably affixed to the main mast to maximize radio frequency performance and minimize interference. Each arm may include a single antenna or multiple antennae. Multiple elements may combine to form a single antenna. Any suitable antenna or antennae combination may be used. It is expected that the antenna will be chosen based upon mission needs and antenna technology available at the time. A description of some exemplary antennae and combinations is discussed below. Another example of how the antenna elements can be deployed: The rotation may be aided solely by the force of gravity such that when the main mast reaches a vertical position, the arms fall to the deployed position. For example, the antenna elements could be rotatably affixed at one end to the main mast and slidably affixed at another point via a cuff or other slidable component, such that as the main mast raises, the cuff slides along the length of the main mast and pushes the antenna elements into a deployed position. Alternatively, the rotation of the antenna elements could be governed by an additional actuator, for example a servo motor. This motor could be operated by sensors, deploying automatically when the UUV surfaces, and retracting automatically when the UUV descends, or manually via remote operator, or via other control. To the main mast is also affixed an antenna element that is at the top of the structure, or near the top, such that the antenna element has a clear view of the sky.

The system is capable of robust multi-band RF performance within a robust mechanical design. Simulations baselined expected RF performance, and prototypes were built and tested under relevant conditions to confirm simulation results. As built, the antenna elements show relatively high impedance matching in RF bands of interest, indicated by measured Voltage Standing Wave Ratios (VSWR) of 2:1 or less, with a maximum impedance of 50 ohms. Anechoic chamber testing and RF testing over saltwater shows attainable gain of at least 3dBic in the bands of interest. Anechoic chamber testing also validated simulations of co-located antenna elements demonstrating no negative interference effects on performance.

The mechanical design was prototyped and tested in lab and on a UUV body in waves. Lab testing showed the actuation subsystem completed over 100 deployment and retraction cycles without mechanical failure. At-sea testing on a 10″ UUV body towed up to 5 knots speed showed the lightweight design survives sea-state 2 surface conditions without structural failure. In some embodiments, the system has a nominal dry weight of 5.5 lbs with ample structural and electrical margins for weight reduction. Even at the nominal weight, the system has negligible effect on roll stiffness for a reference 12.75″ diameter UUV. With these results, a prototype has achieved TRL 6 and looks ahead to antenna integration to an operational UUV.

High RF Performance in the Ocean Environment is critical. This system's dipole configurations for both the very high frequency and ultra-high frequency antenna elements are particularly robust to multipath interference caused by ocean waves and tolerate dynamic motion.

The system is tall enough for good RF performance while keeping center of mass low when fully deployed, avoiding inducing excessive UUV motions. The elements are arranged to minimize/avoid interference effects from co-location, the conductive UUV hull, and the conductive sea surface. The ultra-high frequency band antenna element at the top supports dual polarization. Additionally, the antenna structure can be selectively angled to increase very high frequency and ultra-high frequency signal gain at high latitudes while the UUV is driving on the surface.

The antenna elements are able to function independently of each other. The antenna can be constructed with any one or all of the described antenna elements. Additionally, more ultra-high frequency elements or other components relevant to mission (such as but not limited to cameras and underwater environmental monitoring sensors) can be added to the system. The system lowers UUV vulnerable time at surface. In some embodiments, the system has powerful actuators which quickly deploy and retract the antenna within 5 seconds. In some embodiments, the system is designed and configured to stow the antenna while the vehicle is submerged and underway at 3 knots, allowing the vehicle to get off the surface faster.

The system has robust, fault-tolerant mechanical design. A prototype has been taken to sea. Mechanical compliance can be built into all critical joints on the modular antenna structure, and actuators may be back drivable to accommodate sea state 2 wave impacts. In the event of an electrical fault where power is lost, the system may stow itself, for example under the force of gravity alone. If all else fails and the antenna cannot be stowed, the system may be provided with the ability to jettison the backpack. These options may be selectively employed via actuation by sensors or via remote actuation. The UUV embedded systems control the jettisoning of the antenna. When the UUV or UUV controller (user) decides to jettison the antenna, the UUV sends electrical signals to a jettison mechanism within the antenna stowage volume. This jettison mechanism (which can have many embodiments) performs two functions under that command: (1) sever the attachment that straps the antenna system to the hull; and (2) sever the electrical connections between the antenna system and the UUV. The jettison mechanism may be, but is not limited to, a hot wire knife, a burn wire, or a knife that is mechanically actuated.

In some embodiments, the system fully integrates the mechanical and RF designs useful in sea environments, incorporating vehicle integration constraints and aligning system performance criteria with evolving needs.

Any suitable RF antenna approach may be used. However, robust multi-band coverage may be achieved by three antenna element system. Arrangement of these antennas is guided by co-site interference concerns. For example, the following antennae were employed in a prototype system.

Very high frequency coverage: Zenith-looking circular polarized dipole in a turnstile configuration 13.2 inches in total diameter. The turnstile configuration provides a more compact architecture than a helical configuration and is easier to impedance match than a loop configuration.

Ultrahigh frequency coverage: Zenith-looking circular polarized dipole with a feed pattern that supports both RHCP and LHCP polarization. The dipole configuration provides a more compact architecture than a helical configuration which can only support one type of polarization.

High Frequency coverage: Vertically polarized structure positioned between the ultra-high and very high frequency antenna elements provides high frequency capability. The element employs a 16″ monopole configuration with omni-directional radiation, suitable for high performance in low-angle skywave type communications. The element is positioned to avoid co-location interference with the neighboring elements and utilizes the full height of the antenna structure for higher attainable gain. This element is proposed as an add-on capability to the modular antenna structure. A monocone structure was also studied and would also be more suitable to low-angle skywave type communications if desired.

A 16 inch crossed wire loop configuration was also studied and would be more suitable for high angle skywave communications if desired.

A second prototype was developed to assess RF performance metrics such as attainable gain, gain patterns, impedance matching, and ground plane effects due to the conductive sea surface and the UUV hull. Simulations of RF performance in very high frequency bands of interest showed high impedance matching (VSWR 2:1 or below) and attainable gain of 3dBic at various tilt angles for the antenna. Simulations allowed for iterative placement of the very high frequency dipoles to remove ground plane and platform interference effects. Testing in an anechoic chamber and testing over saltwater validated performance simulations. Simulations of RF performance in the ultra-high frequency bands also showed high impedance matching (VSWR 2:1 or below) and attainable gain of 3dBic in the objective range. Gain also was simulated on the platform with the ultra-high frequency element positioned over the very high frequency dipoles, and there were no simulated losses due to the co-location. Anechoic chamber testing of the antenna integrated configuration validated these simulations. Test results were overall in good agreement with simulations, validating electrical models. In this manner, antenna performance has been effectively baselined with high-fidelity component-level testing.

Choice of materials and construction techniques must take into account the sea environment as well as pressure tolerance. This is true of the housing as well as all electrical components in the system, including the antenna feed components.

The system is designed to be neutrally buoyant relative to the UUV when the UUV is submerged and/or underway. To meet neutral buoyancy requirements, the housing is designed as a wet volume and syntactic foam may be employed within the housing to further offset water displacement by the antenna. This syntactic foam is pressure tolerant to meet survivability requirements for use in the subsea environment.

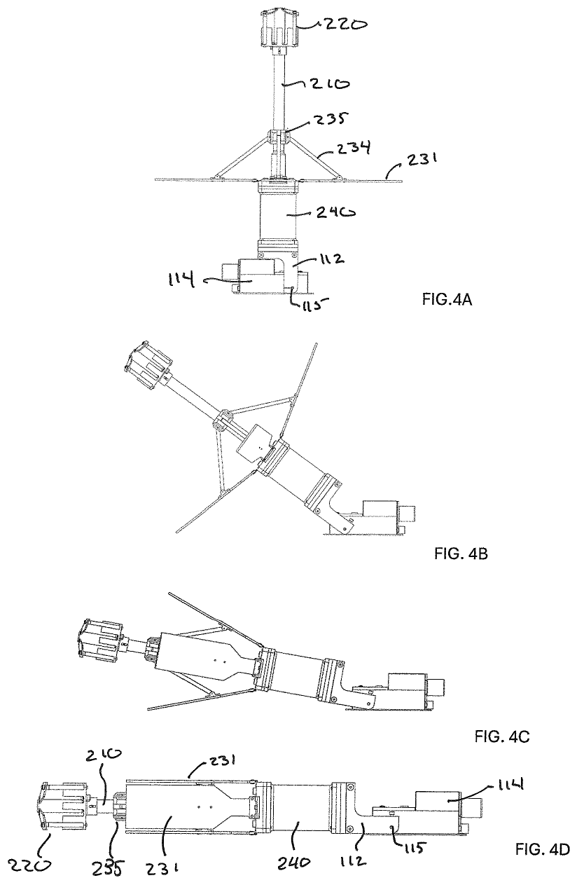

A first prototype was developed to define the Size, Weight and Power (SWaP) operational envelope of the system and to demonstrate the robustness of the actuation mechanism. (See FIGS. 4A and 4B.) The prototypes used were mutually compatible to ensure seamless final integration during Phase II.

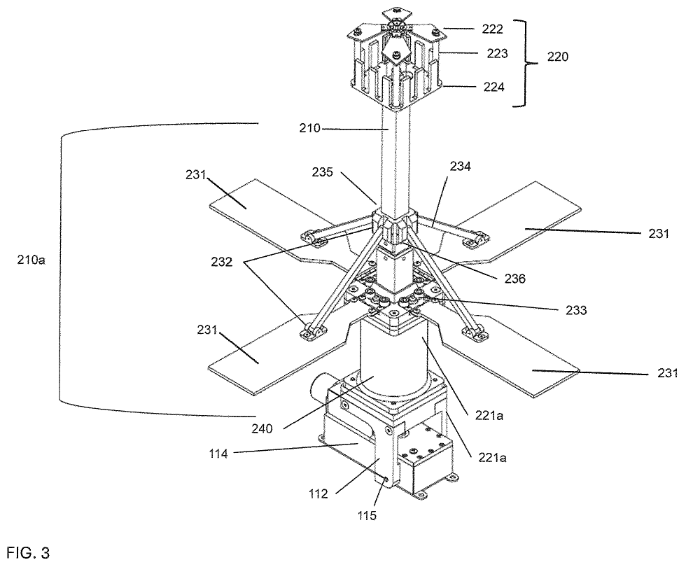

The first prototype was developed to validate actuation subsystem design and quantify system reliability. Mechanical models showed safety factors for all structural components above 2, and a safety margin of 2 on actuator torque capacity. The first prototype was subjected to benchtop testing under ideal conditions. Deployment and retraction cycles were set to a duration of 5 seconds each. The system completed through over 100 cycles at various directional angles without failure. Also, the power draw of the actuation system for the full margin of antenna element dry weight has been established, providing a specification critical to future vehicle integration efforts. The system nominal dry and wet weight have been well characterized, and indicate the system is lightweight enough to have minimal effects on vehicle roll stiffness. This also indicates the system will not affect a vehicle's behavior while flying underwater. Given these findings, the first prototype has ultimately been demonstrated in a relevant environment on a test 10″ UUV body, shown in FIG. 3. The system was strapped on an unpowered fully deployed state. The UUV body was then towed up to 5 knots in various wave-action conditions. In one of many occasions, the antenna successfully faced a 12-15″ high wave impact. The prototype had no structural failures. Furthermore, in its unpowered state the system required moderate handling force to stow the antenna, leveraging the back drivability of the actuation servos.

In some embodiments, the antenna system is a completely flooded system, with the exception of the pressure vessel at the base of the antenna mast. As such, the antenna system (including the housing) is designed for full ocean depth. The construction of the housing may be anything, such as but not limited to, of buoyant material such as syntactic foam coated for a desired surface texture, a composite part such as fiberglass, or rigid solid material such as molded plastics, cast metal, machined metal or machined plastics.

In some embodiments, the system gets its power from the UUV. The system is designed to fail in a closed state to ensure the antenna can be retracted in the event of a failure and ensure the vehicle can be recovered: If the actuator loses power, the antenna cannot hold itself up, and it will fall down into the stowage volume due to gravity, stowing itself. If the antenna is mechanically pushed past its deployed position or the actuator is overloaded, there is a spring pin inside the servo assembly that is designed to break as a shear pin would (when it experiences a load past its design limit). When the pin breaks, the antenna cannot hold itself up and as above, stows itself due to gravity.

In some embodiments, the antenna system is designed to fail in a closed state to ensure the antenna can be retracted in the event of a failure and ensure the vehicle can be recovered. The antenna is largely comprised of rigid materials of high tensile strength, inherently impact resistant to handling loads and operational loads typical to the operation of UUVs. When deployed, the antenna components can absorb significant impact. When stowed, the antenna stowage volume can absorb significant impact.

If the antenna is subjected to unexpected or extraneous impact or collision while deployed, there is a spring pin inside the servo assembly that is designed to break as a shear pin would (when it experiences a load past its design limit). When the pin breaks, the antenna cannot hold itself up; it will fall down into the stowage volume due to gravity, stowing itself.

If the antenna system is impacted while stowed and becomes non-functional, the UUV can command the jettison mechanism in the stowage volume to jettison the whole system.

In some embodiments, the antenna system is operational only when the UUV is at the surface of the water and in a deployed position. When deployed, drag is not of any concern. Otherwise, the antenna system is in its stowed position. In this position, the housing is designed to provide minimum drag to the platform while underway. The required drag profile of the stowage volume is specified by the UUV manufacturer. The drag reduction requirements are reliant on the geometry of the UUV.

FIG. 1A depicts a UUV with a retractable antenna system in accordance with some embodiments described herein. FIG. 1 depicts and undeployed, retracted position. As can be seen, a UUV 500 is provided. The retractable antenna system includes an attachment mechanism 150, such as straps, clamps, latches, etc. for affixing the system to the UUV. In a stowed position, as in FIG. 1A only the exterior of the retractable antenna systems is visible. Housing 100 is shaped for good hydrodynamics in the water, to minimize the effect on drag. The housing 100 may have buoyancy fairings 110, and is provided with one or more access panel, e.g., a door 120, which selectively opens to allow the antenna assembly to deploy and closes when the antenna assembly is stowed.

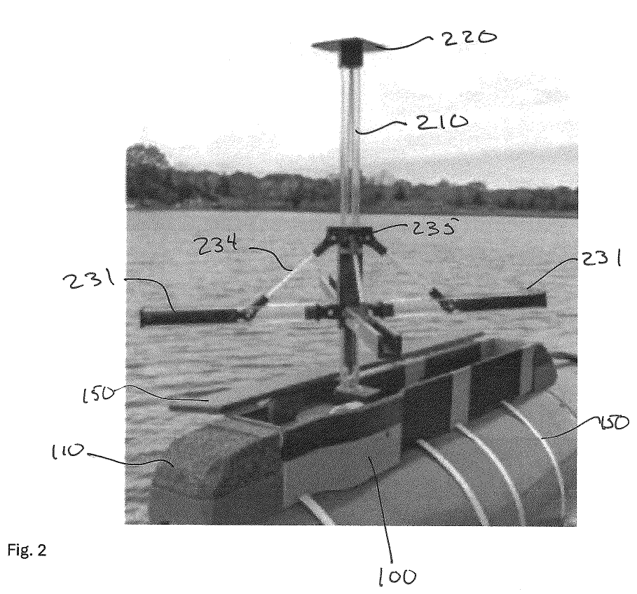

FIG. 1B shows the same system in a deployed position. In the deployed positions, the antenna assembly 200 becomes visible. Here, we see housing doors 120 are open, and the antenna assembly 200 is positioned at approximately 90° from the horizontal (i.e., the surface of the UUV). The antenna assembly 200 may be deployed at substantially any angle. The antenna assembly includes at least 2 (220, 222) and preferably 3 antennae, a central mast 210, a yoke 112, and an actuator 114. All of the components fold into and out of a stowage volume created by the housing 100. FIG. 2 is a photo of an exemplary system in accordance with some embodiments. FIG. 3 is a schematic depicting that embodiment.

The main structure is defined by a pressure vessel 240 and a central mast 210.

The actuator 114 may be any suitable motor or other device, for example, a brushless servo, mechanically coupled to a gearbox for higher mechanical advantage. This mechanical drivetrain is encapsulated in a pressure balanced oil filled housing, enabling operation in full ocean depth.

The actuator 114 is fastened to the stowage volume (housing) 100. It is fixed against movement. The antenna assembly 200 is rotatably coupled to the actuator 114 via a yoke 112 at the base of the main structure that grips the actuator output shaft 115.

There are dielectric isolators 221a between the yoke 114 and the high frequency antenna element.

The first antenna element 220 is mounted atop the central mast. The second antenna element 230 is mounted on the central mast. The mast 210, itself, may include a third antenna element. There are dielectric isolators between the second antenna element 230, which is a high frequency antenna element and the very high frequency elements 231. There are dielectric isolators between the second antenna element 230 (high frequency antenna element) and the first antenna element 100 which is ultra-high frequency antenna atop the central mast 210.

The second antenna element 230 comprises very high frequency antenna elements which are mechanically mounted to the central mast via spring hinges 233. These hinges 233 are also the coaxial feed terminations of the elements, providing RF signal between the frequency filters in the pressure vessel and the radiative elements (dipoles) 231.

Each dipole 231 is linked to a runner 235 via a plastic linkage 234 that has fixed rotating pin joints on either interface. The runner 235 slides freely along the central mast 110, mechanically coupled to the dipoles 231 via the linkages 234.

The first antenna element 220, e.g. an ultra-high frequency antenna, sits atop the central mast with its own electrical ground plane. The ultra-high frequency antenna includes ultra-high frequency dipoles 222, an ultra-high frequency ground plate 223 with dielectric isolators 221 therebetween.

FIGS. 4A-4D depicts various stages of the retraction process. The deployment process is simply the reverse procedure.

FIG. 4A shows the actuator 114 is powered and holding the antenna assembly 200 at the desired deployed angle. The dipole spring hinges 233 are in the neutral position, keeping dipoles 231 of the second antenna element 230 deployed. The runner 235 rests on the mechanical stop 236, keeping dipoles 231 deployed.

As shown in FIG. 4B to retract, the actuator 114 is powered and rotates the mast 210 downward toward the housing (not shown for clarity). One dipole 231 makes contact with the floor of the stowage volume (housing) and forces the dipole hinges 233 to compress. The second antenna element 230 begins to fold in place along the mast 210. As the one dipole folds, the linkage 234 causes the runner 235 to slide up the central mast 210. The other dipoles are mechanically linked to the runner 235. The runner's translation up the mast pulls on the other dipoles to similarly fold.

FIG. 4C, shows the actuator continues to rotate the antenna down and the dipoles 231 of the second antenna 230 continue to fold into place, becoming more compact for storage.

In FIG. 4D the antenna assembly is fully retracted. In some embodiments, the yoke 112, or other portion of the antenna assembly, makes contact with a mechanism in the stowage volume, such as a limit switch, that indicates to the embedded systems the servo should stop rotation. The same switch may be used to trigger closing of the housing access panel 120. The dipoles are now folded, and the antenna is stowed.

The access panel 120 or doors are not shown to better illustrate the antenna assembly. However, any suitable access panel 120, that allows opening of the housing to facilitate movement of the antenna into and out of the housing may be used. The opening and closing of the access panel may be achieved through any means, such as, but not limited to, additional linkages connecting the door and the actuator or mast such that the access panel opens and closes due to a mechanical relationship or the use of one or more actuators. The access panel may be coupled to the same actuator or its own actuator to facilitate opening and closing.

The antenna system is a completely flooded system, with the exception of the pressure vessel at the base of the antenna mast. As such, the antenna system (including the housing) is designed for full ocean depth. The construction of the housing may be anything, such as but not limited to, of buoyant material such as syntactic foam coated for a desired surface texture, a composite part such as fiberglass, or rigid solid material such as molded plastics, cast metal, machined metal or machined plastics.

In some embodiments, the system gets its power from the UUV. The system is designed to fail in a closed state to ensure the antenna can be retracted in the event of a failure and ensure the vehicle can be recovered. If the actuator loses power, the antenna cannot hold itself up, and it will fall down into the stowage volume due to gravity, stowing itself. If the antenna is mechanically pushed past its deployed position or the actuator is overloaded, there is a spring pin inside the servo assembly that is designed to break as a shear pin would (when it experiences a load past its design limit). When the pin breaks, the antenna cannot hold itself up and as above, stows itself due to gravity.

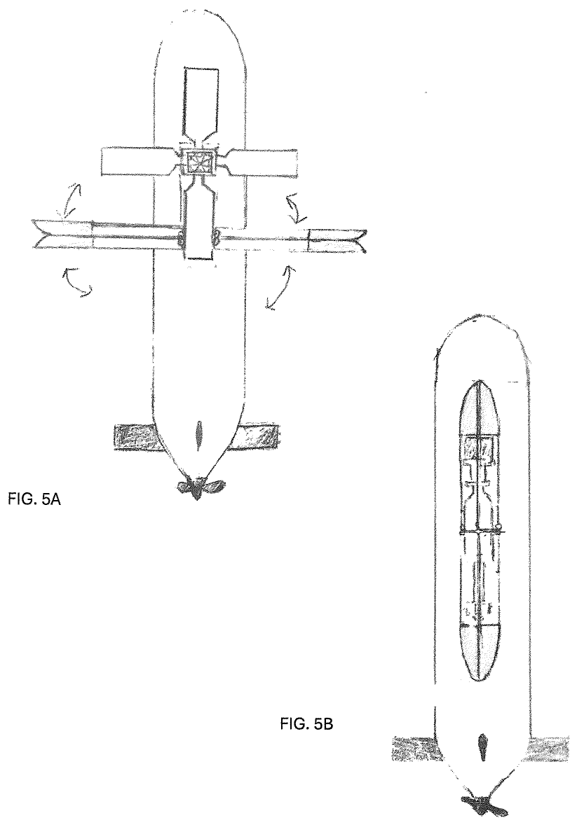

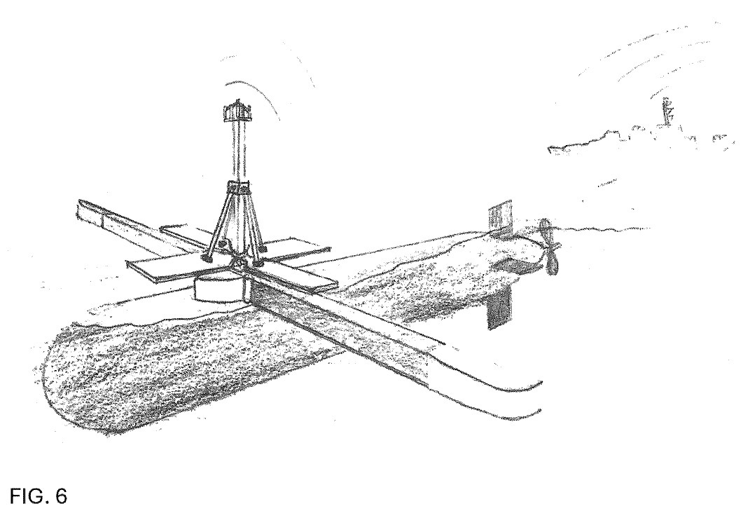

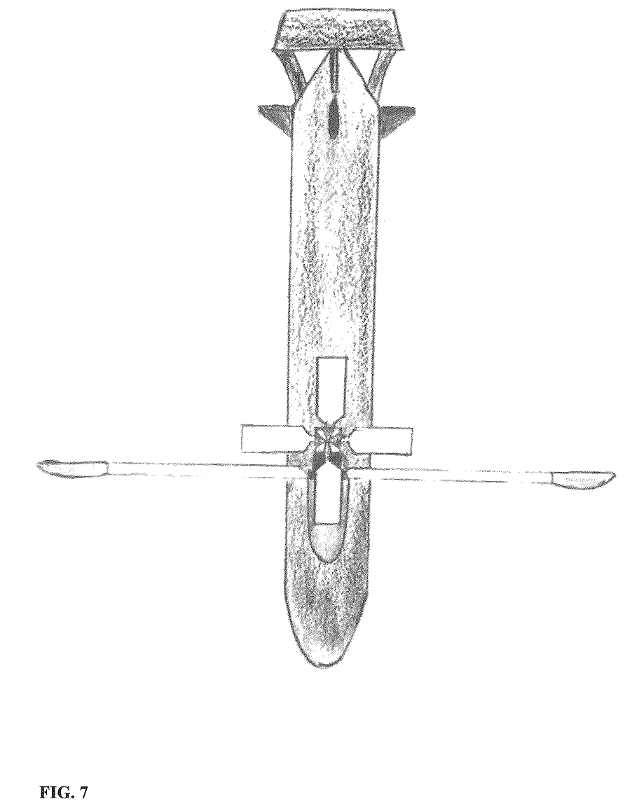

The system may also be provided with additional stabilization means, such as outriggers. The outriggers will be deployed and retracted along with the antennae. FIGS. 5A-5B show some exemplary arrangements. FIGS. 5A and 5B show an exemplary outrigger system employing four outrigger arms that further comprise two forward facing outrigger arms and two rear facing outrigger arms. When deployed, each forward and rear outrigger arm extends outwardly from a hinged location on the housing, such that opposed outrigger pairs are deployed on either side of the UUV, perpendicular to the length of the UUV. In a stowed position, as shown in FIG. 5B, the forward pair of outrigger arms are hinged forward into contact with one another, and the rear pair of outrigger arms are hinged backwards into contact with one another. As shown, it is preferable if the respective ends form a hydrodynamically efficient edge in the stowed position. FIG. 6 depicts a perspective view of a fully deployed system with outrigger arms. FIG. 7 depicts an alternative design, with a single outrigger arm on each side (left and right), rather than a pair of forward outriggers and a pair of rear outriggers. In some embodiments the outrigger arms are designed and configured to make up at least a portion of the housing to save on weight and materials.

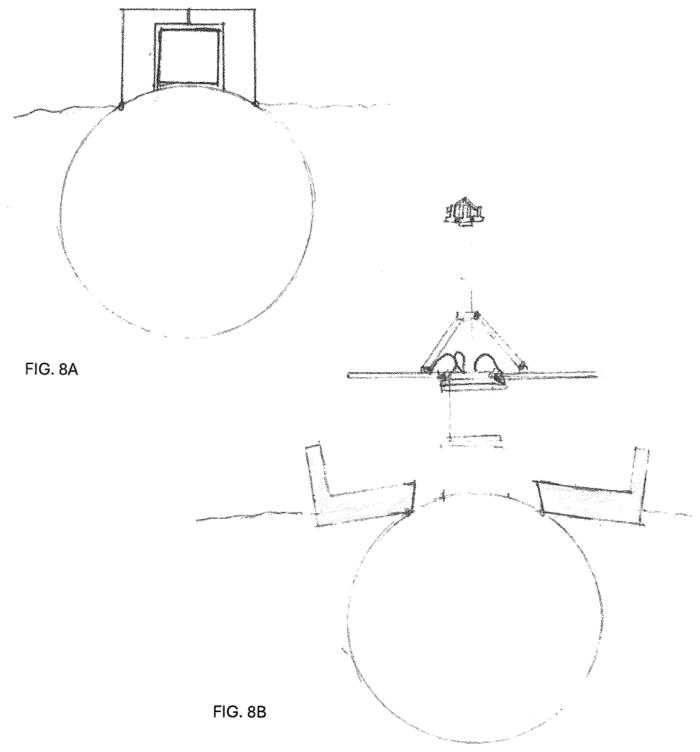

FIGS. 8A and 8B depict an alternative outrigger arrangement, where the sidewalls of the housing are hinged along the UUV so as to open outwardly to form the outrigger arms. FIG. 8A is a schematic cross-sectional view showing the outriggers in a stowed position where they form the walls of the housing within which the radar array is disposed. FIG. 8B shows the deployed position, with the radar array in its full upright, deployed position, and the housing 100 sidewalls fully open in outrigger position.

The technical adjustments can be readily made to improve on the field readiness of the system. The system is readily adaptable to refine the mechanical design to effectively integrate the actuation and antenna subsystems. Positive structural margins on critical components and on the torque capability of the actuation servos show there is ample opportunity for weight reductions across the system, including selection of even more compact actuators. The mechanical subsystem may be revised for integration of required buoyancy fairings and the jettison capability.

Below are described some additional embodiments:

GRAVITY FED SYSTEM WITH SPRING ASSIST All embodiments in this category assume the hinged dipoles are mechanically coupled to each other, such that moving one moves them all. In this embodiment, the hinge neutral position is open. When the antenna is rotated up from a horizontal position, the dipoles are no longer constrained by the stowage volume and the hinge spring force opens the hinges, unfolding or deploying the dipoles. Deployment is assisted by the gravity force on the runner, which is able to slide down a low-friction section of the central mast. Deployment is also assisted by the gravity force on (also referred to as weight of) the dipoles themselves.

GRAVITY FED SYSTEM, NO SPRING ASSIST All embodiments in this category assume the hinged dipoles are mechanically coupled to each other, such that moving one moves them all.

In this embodiment, the dipole hinges do not have springs; the runner is able to slide on a low-friction section of central mast. When the antenna is rotated up from a horizontal position, the dipoles are no longer constrained by the stowage volume. Deployment of the dipoles is primarily due to gravity force acting on (also referred to as weight of) the dipoles themselves. The dipoles are weighted at their tips to increase this resultant mechanical lever arm. Deployment is further assisted by the gravity force on (also referred to as weight of) the runner.

In this embodiment, the dipole hinges do not have springs; the runner is able to slide on a low-friction section of central mast. The runner is heavily weighted. When the antenna is rotated up from a horizontal position, the dipoles are no longer constrained by the stowage volume. Deployment of the dipoles is primarily due to the gravity force acting on (also referred to as weight of) the runner. Deployment is further assisted by gravity force acting on (also referred to as weight of) the dipoles themselves.

ACTUATOR In this embodiment, the dipole hinges can have springs. A cord is tied one end to the runner which is able to slide down a low-friction section of the central mast; on the other the cord is tied to a mechanical actuator such as a winch at base of the antenna. This actuator is separate from the actuator that rotates the antenna assembly to/from stowed and deployed positions. In the cord's neutral position, the runner is in a low position with dipoles open/deployed. To stow the antenna, the winch winds the cord; the cord pulls on the runner, moving the runner up, folding in the dipoles. The actuator used to rotate the antenna could also serve to winch the dipoles open by employing using a spring to hold the dipoles closed until the winch has pulled the mast upright. Once the mast has reached the upright position it will contact a stop and the force of the winch will then begin to act against the spring(s) extending the dipole arms. The process will proceed in reverse to retract the system. The spring force will cause the arms to retract as the winch releases the cord, a 2nd weaker spring will cause the mast to retract once the arms are fully retracted. Alternatively, a positional clutch could be used to switch between the two mechanisms.

In this embodiment, the dipole hinges can have springs. Also, the hinged dipoles are mechanically coupled to each other, such that moving one moves them all. A cord is tied to one dipole and a separate mechanical actuator such as a winch or a servo at base of the antenna. When the antenna is rotated to an upright position, the servo pulls on the cord (or the winch winds the cord around a drum). By this action, the cord pulls the dipoles down, bringing the antenna to a deployed position. Deployment can be further assisted by the stored spring force in the dipole hinges that work to open the hinge. Alternatively, the stored spring force in the dipole hinges can be set to work to keep the hinges bent (resulting in the dipoles in the folded position). In this case, the cord pulling the dipoles open is acting against the sprung hinge. A key benefit of this design is that the antenna is naturally in a retractable state, ensuring safe vehicle recovery.

STATIC CORD/LINKAGE In this embodiment, the dipole hinges can have springs. Also, the hinged dipoles are mechanically coupled to each other, such that moving one moves them all. A cord or linkage arm or set of arms is connected to the stowage volume and to one dipole or directly to the slider. When the antenna is rotated to an upright position, the cord pulls the dipoles down, bringing the antenna to a deployed position. Key benefits of this design are the low mechanical complexity and the opportunity for implementing lightweight components for the runner and dipoles. Deployment can be further assisted by the stored spring force in the dipole hinges that work to open the hinge. Alternatively, the stored spring force in the dipole hinges can be set to work to keep the hinges bent (resulting in the dipoles in the folded position). In this case, the cord pulling the dipoles open is acting against the sprung hinge. A key benefit of this design is that the antenna is naturally in a retractable state, ensuring safe vehicle recovery.

SPRING-ASSISTED UMBRELLA MECHANISM In this embodiment, the hinged dipoles are mechanically coupled to each other, such that moving one moves them all. In this embodiment, the dipole hinges can have springs. The runner is positioned below the dipoles rather than above (as in previous embodiments) and has mechanical linkages to the tips of the dipoles of dielectric material. As the antenna is rotated to an upright position, the dipoles are no longer constrained by the stowage volume and the stored spring energy in the dipole hinges folds the dipoles up. Deployment is assisted by the runner moving up along a low-friction section of the central mast, pushing the dipoles up and out. To retract the antenna, the runner may be constrained by a spring internal to the central mast. When the runner moves up to deploy the antenna, the spring is stretched. The dipoles are held out by the hinge springs. When the antenna is stowed, the stowage volume guides one dipole to fold down, moving the runner down the mast, its movement further assisted by the runner spring wanting to return to the neutral state, stowing the rest of the dipoles.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. Therefore, about 50% means in the range of 45%-55%.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also understood that this disclosure is not limited to particular compositions, methods, apparatus, and articles, as these may vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 antennae refers to groups having 1, 2, or 3 antennae. Similarly, a group having 1-5 antennae refers to groups having 1, 2, 3, 4, or 5 antennae, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A retractable antenna system for use with an unmanned undersea vehicle (UUV) for improved communications in sea environments, the retractable antenna system comprising:
a housing; and
a retractable antenna system, capable of selective deployment out of and retraction into the housing, the retractable antenna system comprising: a central mast terminating at one end with a yoke, and an actuator, which is affixed to the housing, such that the central mast may rotate into and out of the housing via activation of the actuator;
further comprising at least two antenna elements, at least one of which is adapted to unfold from the mast during deployment such that it extends laterally from the central mast.

2. The retractable antenna system of claim 1, wherein the housing further comprises a hydrodynamically shaped housing to minimize drag, an access panel selectively moveable between open and closed states to facilitate deployment or retraction of the antenna system.

3. The retractable antenna system of claim 2, wherein the access panel is selected from one or more doors or panels.

4. The retractable antenna system of claim 1, wherein the retractable antenna system comprises:
a main mast, which is rotatably affixed at one end to the housing, such that when deployed, the main mast can rotate and maintain a position that is about 0 degrees to about 90 degrees from horizontal,
a plurality of antenna elements each of which is rotatably affixed to the main mast, and selectively moveable between a stowed position and a deployed position.

5. The system of claim 4, wherein the size and placement of the antenna elements is selected based up a number of parameters including UUV size, mission, antenna interference concerns, or combinations thereof.

6. The system of claim 1, wherein the attachment means for affixing the system externally to the UUV allows for permanent attachment of the system to the UUV.

7. The system of claim 1, wherein the attachment means for affixing the system externally to the UUV allows for removable attachment of the system to the UUV.

8. The system of claim 7, wherein the attachment means include a plurality of straps which extend around the UUV body and attach to opposite sides of the housing to secure the housing to the UUV.

9. The system of claim 1, wherein one or more different type of antennae or other sensory equipment are deployed.

10. A retractable antenna system for use with an unmanned undersea vehicle (UUV) for improved communications in sea environments, the retractable antenna system comprising:
a housing having
a hydrodynamic shape to reduce drag,
a lower surface which is sized and configured to compliment the size and
shape of the UUV to which it is attached,
one or more buoyancy fairings,
one or more access panel selectively moveable between open and closed states
to facilitate deployment or retraction of the antenna system;
and
an antenna assembly, capable of selective deployment out of and retraction into the housing,
the antenna assembly comprising:
a mast having a longitudinal axis,
a first antenna, mounted atop the mast,
a second antenna comprising one or more retractable antenna element, wherein
the second antenna opens to a position substantially perpendicular to a longitudinal axis of the mast in a deployed status and closes to a position substantially parallel and adjacent to the mast when in an un-deployed status,
wherein the mast is rotatably coupled to the housing, and operably coupled to an actuator for movement between deployed status and un-deployed status.

11. The retractable antenna system of claim 10, wherein the mast comprises a third antenna.

12. The retractable antenna system of claim 11, wherein:
the third antenna is a high frequency antenna,
the second antenna is a very high frequency antenna, and
the first antenna is a multi-function ultra-high frequency antenna.

13. The retractable antenna system of claim 10, wherein the second antenna comprises 2 or more dipole antenna elements arranged opposite one another about the mast, and attached to the mast via hinges and wherein each dipole antenna element is connected by a linkage to a runner which is mounted to slide along the length of the mast, such that each dipole antenna element rotates together from retracted to deployed positions.

14. The retractable antenna system of claim 10, further comprising attachment means for affixing the housing externally to the unmanned undersea vehicle (UUV).
